(19) United States
(12) Patent Application Publication
(10) Pub. No.: US 2013/0069877 A1
(43) Pub. Date: Mar. 21, 2013

(54) MOUSE HAVING A CLICKING FUNCTION VIA AUDIO OR LIGHT SIGNAL

(71) Applicant: Steve CHA, Franklin Lakes, NJ (US)

(72) Inventor: Steve CHA, Franklin Lakes, NJ (US)

(21) Appl. No.: 13/252,526

(22) Filed: Oct. 4, 2011

Related U.S. Application Data
(60) Provisional application No. 61/536,167, filed on Sep. 19, 2011.

(51) Int. Cl. G06F 3/033

(52) U.S. Cl. 345/166

(57) ABSTRACT

An input device providing less strain on the user is disclosed. The input device comprises a means for tracking movement of the device and providing a signal associated with the movement to a computer system and means for receiving one of an audio signal, an optical signal and a verbal expression and providing associated signals to the computer system, wherein the computer system executes a function identified by a position determined based on the movement information and the received one of: audio signal, optical signal and verbal expression.

### CLAIM OF PRIORITY

This application claims, pursuant to 35 USC 119, priority to, and the benefit of the earlier filing date of, that provisional patent application entitled “Mouse Having a Clicking Function via Audio or Light Signal,” filed in the US Patent Office on Sep. 19, 2011 and afforded Ser. No. 61/536,167, the contents of which are incorporated the reference herein.

### FIELD OF THE INVENTION

The present invention relates to the field of input devices and to a device that allows coordinated data inputs.

### BACKGROUND OF THE INVENTION

Input devices, such as computer mice, are well known in the computer arts. These types of devices, generally referred to point-and-click devices, are common in the computer field and work in conjunction with a graphic user interface (GUI) to simplify the access to applications and/or information stored in the computer. Typically, the computer mouse (or similar devices, such as a pen/tablet input) provides movement direction signals to a computer system that enables the computer system to move or direct a cursor along a computer screen. When a desired function, application or data element is located at a position covered or indicated by the cursor, a click (or a double click) on a button (typically the left button) causes the computer system to select (single click) or execute (double-click) the application or data element, represented by an icon, at the position identified by the cursor. The single or double click provides the instruction to the computer system to operate-on the selected item (e.g., open selected data item and/or execute an application program).

Another typical command is “drag and click” were the concurrent depression of the left button (typically) and moving the input device, causes the computer system to select the icon at the current position of the cursor and moves the icon in accordance with the movement of the cursor.

However, the repetitive action of clicking the computer mouse button (or other similar type devices) has been known to induce pains in a user's muscles, tendons or nerves of the neck, shoulder, forearm and hand. Over significant time, it has been found that the repetitive use of the mouse cause Repetitive Strain Injury (RSI). RSI is also known as repetitive motion injuries, repetitive motion disorder, cumulative trauma disorder, and regional musculoskeletal disorder. The most common injury is known as Carpal Tunnel Syndrome.

To prevent the RSI problem, user may opt to switch mouse hands or take breaks from performing this repetitive motion. However, it may take a significant time to develop the skills to maneuver a mouse with a hand other than the dominant hand. In addition, by performing the same action with a different hand may introduce RSI in the other hand and, thus, have two sore wrists instead of one. Alternatively, the user may not be able to take the breaks in work that would reduce the time spent managing and control the movement of the mouse.

However, if a user can avoid the repetitive clicking that occurs during operation of the PC, the user can eliminate discomfort or pain associated with the mouse operation.

Hence, there is a need in the industry to provide a device that allows a user to reduce the repetitive actions necessary to manage and control the operation of a computer system.

### SUMMARY OF THE INVENTION

In one aspect of the invention, a mouse having an audio or light (optical) sensor that allows for a clicking action can be realized by generating an audio signal in a variety of ways. For example, a user can generate verbal commands or using a second hand, a foot, or another part of the body as the user moves the mouse to a desired location. Alternatively, a light sensor can generate a light beam from the mouse, and when the user covers the light beam or light source, the interruption is deemed to correspond to a clicking operation. Further, the user can be provided with a third device that can simulate the clicking activation without using their finger on the mouse. For example, a mouse pad can have a sensor for detecting any type of tapping (i.e., a percussion event) thereon, which generates an input command signal that is used to activate a clicking action. Similarly, a footpad can be provided so that when the user performs an action (e.g., a depression or tap on the footpad), the footpad may generates an input command signal that causes a response similar to a clicking operation.

According to the teachings of the invention, a user can replace the traditional clicking action of depression of a mouse button by moving the mouse to a desired location, and activating the clicking command via an audio, a light, and/or another device that can receive an audio, a manual contact, and/or light signal so as to be equivalent to the traditional clicking motion on the mouse.

The third party device can be a traditional stand-alone microphone connected to a computing device through a wired or a wireless connection. In addition, the microphone may be incorporated into a computer or a computer monitor to pick up an audio signal. In this case, the third party device may generate a noise or other audio sound when a tap action is performed. The audio sound is captured and operated on in a manner similar to a click action. In another aspect, the third party device may detect verbal expressions that are provided to the input device. The verbal expressions may be one of an audio sound (similar to a tapping action) or may be a verbal command, such as “click,” “double click,” “right click,” etc. A microphone, for example, may be used to capture (or generate) an audio sound or may be used to capture a verbal expression, that is then translated into appropriate signals so that an appropriate corresponding action may occur.

In another aspect of the invention, a longer audio signal, a longer light signal or other type signal may be used in conjunction with an audio sound that may be used to indicate clicking action to simulate a traditional mouse “click and drag” operation. For example, the user may whistle for a fixed duration when the mouse is used to drag a particular item. When the whistling stops, the dragging operation also stops. In this case, a first audio input may be used as a click but if the audio input continues for a period greater than a predetermined time, the audio input is interpreted as a click and drag action.

In another aspect of the invention, an earphone device can be used capture audio sounds or a verbal expression indicative of a clicking command and provide the captured sound or verbal expression to the input device for translation to appropriate signals provided to the computer system. Alternatively, the audio signal detected by a sensor on the inventive device disclosed herein can be used to perform dictation, thus eliminating the need for another audio detector.

### BRIEF DESCRIPTION OF THE DRAWINGS

FIG. 1 illustrates a top view of an input device having a sensor according to a first embodiment of the present invention.

FIG. 2A illustrates an exemplary configuration of an input device in accordance with the first embodiment of the invention.

FIG. 2B illustrates an exemplary configuration of an input device in accordance with a second embodiment of the invention.

FIG. 3A illustrates a block diagram of the first embodiment of the input device in accordance with the principles of the invention.

FIG. 3B illustrates a block diagram of the second embodiment of the input device in accordance with the principles of the invention.

FIG. 4 illustrates a flow chart of a process for managing the input device inputs in accordance with a first aspect of the first embodiment of the invention.

FIGS. 5A and 5B illustrate flow charts of a process for managing inputs from an input device in accordance with the second embodiment of the invention.

FIG. 6 illustrates a flow chart of an exemplary process for managing inputs from an input device in accordance with an aspect of the invention.

FIGS. 7A-7C illustrate exemplary signal timing diagrams in accordance with the principles of the invention.

FIG. 8 illustrates and exemplary processing for managing the input command signals in accordance with the principles of the invention.

### DETAILED DESCRIPTION OF THE INVENTION

According to the teachings of the present invention, a mouse device or other similar type handheld device (referred to herein as an input device) can be incorporated as a part of the computer device, laptop, or any portable terminal device so that the user can actuate a clicking operation in a manner different from the conventional mouse.

In one aspect, a sensor can be provided as a part of the display unit or on a predetermined location on a laptop or a portable terminal.

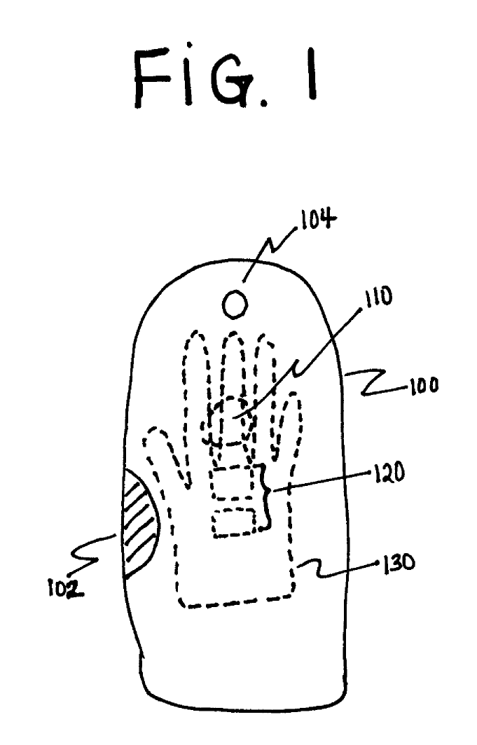

FIG. 1 illustrates a top view an input device 100 in accordance with a first embodiment of the invention. In this illustrated embodiment, the input device (or mouse) may be constructed similar to typical conventional mouse using a ball mechanism 110, which is in contact with a surface upon which the mouse is positioned on (shown in hidden line form) or using a light mechanism 120 that directs a laser light onto a surface upon which the mouse is positioned on (laser transmitter and receiver shown in hidden line form) or using a trackball mouse (not shown) wherein the mouse remains stationary on a surface and the ball mechanism is moved by the user's fingers.

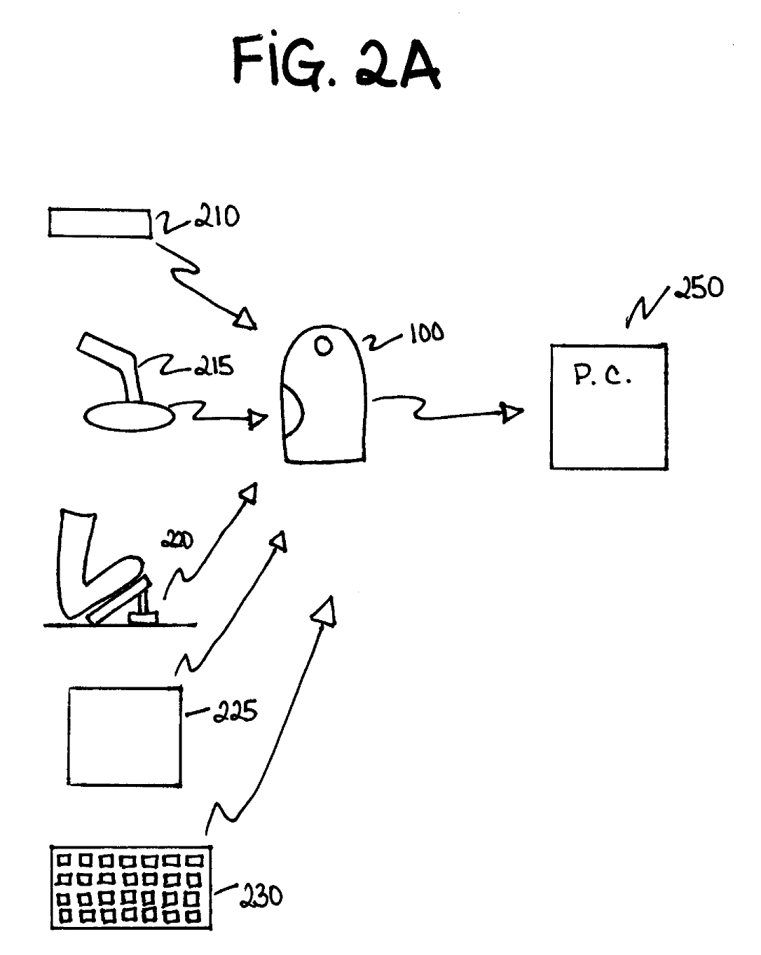

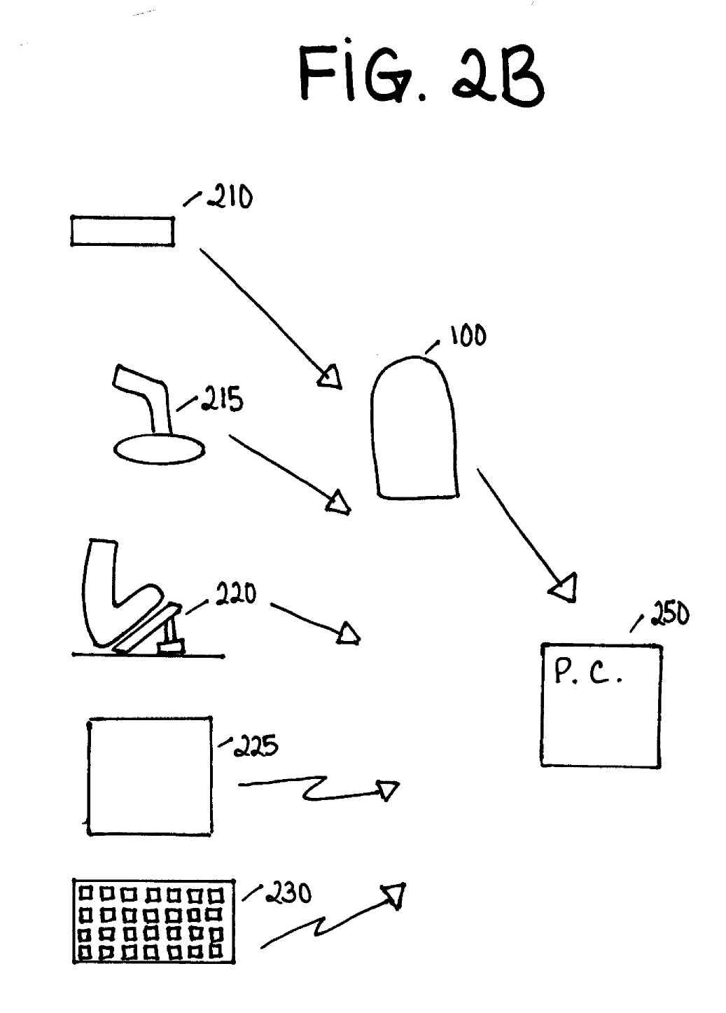

Also shown, on a side of the input device 100 is a sensor 102. The sensor 102 may be an audio sensor, similar to a microphone, or a light sensor. Alternatively, the sensor may be in communication with a plurality of receivers 210, 215, 220, 225, and 230 (shown in FIG. 2). In the case the sensor 102 is an audio sensor, the audio sensor may operate in response to audio command (e.g., an audio sound or a verbal expression such as “click” or “double click”) to cause the mouse to operate as if a conventional button click or double click has occurred. In another aspect, the audio command may be a user set noise command. For example, the user may set a click response to be comparable to a tap (or a percussion event0 on a surface. The tap generates an audio sound that is detected by the audio sensor 102. Similarly, a double tap may represent a double click. The sound associated with the tap or double tap may be detected to by the audio sensor. The sound associated with the tap or double tap may cause the input device, in accordance with the principles of the invention, to respond as if a button depression has occurred on a conventional mouse.

As would be appreciated, the audio command may also be the verbal expression “right click” to indicate a right click action.

In accordance with at least one aspect of the invention, after a cursor controlled by the movement of the mouse is moved to a position corresponding to an icon representing a data item or application item, the verbal expression “click” is then translated into an appropriate set of signals that cause the input device to issue a “click” response similar to that of a button depression (i.e., a click) on a conventional mouse. That is, the input device translates the provided input command signal to conventional signals that are provided to a computer system, which causes the computer system to execute an appropriate function at the location associated with the position of the cursor with respect to the GUI.

Similarly, the verbal expression “double click” may cause the input device to translate the received verbal expression into signals that represent a double click response (i.e., two click responses within a prefixed time period) similar to the double depression of a button within a prefixed time on a conventional mouse.

In another aspect of the invention, when the sensor 102 is a light sensor, the covering of or the passing over the sensor 102 may be interpreted as a “click” again. For example, a user's hand 130 (shown in dashed lines) may be extended over the light sensor 102 to block light for a predetermined period of time. The blockage of light for a first predetermined period of time causes the input device 100 to respond as if a button depression (i.e., a click) has occurred on a conventional mouse. Similarly, if the time the light sensor is covered (blocked) for a second predetermined time (greater than the first predetermined time), then the input device 100 may respond by issuing signals that are similar to those issued as if a “double click” has occurred. In addition, if the light sensor is blocked for a third predetermined time (greater than the second predetermined time), the input may respond as if a “click and drag” request has been made.

In another embodiment of the invention, a sensor 104 may be incorporated on the top of the input device. Similar to the sensor 102, the audio and/or light sensor 104 may be triggered by an audio command or by waving a hand 130 over the light sensor 104. Thus, while the input device in FIG. 1 has been shown to include a sensor 102 on the side to the input device, it would be recognized that the sensor may be incorporated into other locations of the input device without altering the principles of the invention.

FIG. 2A illustrates an application of a second aspect of the first embodiment of the invention, shown in FIG. 1, wherein the input device 100 may be in communication (wired or wireless) with at least one third party device that provides an appropriate input to device 100. For example, the sensor 102 may operate as an audio sensor to detect audio sounds generated by the third party devices. Alternatively, the sensor 102 may operate as a light sensor that detects a blockage of light. Alternatively, the sensor 102 may operate as a receiving system (e.g., an RF receiving system) for receiving inputs from the third party devices. As would be recognized device, 100 and the third party devices may be in communication by an audio link, an optical link, a wired link and a wireless link. However, for the sake of clarity only the wireless communication link is discussed herein. It would be within the skill of those knowledgeable in the art to adapt the device 100 to incorporate wired communications.

For example, device 100 may be in communication with a user through a short-range communication receiving system, wherein sensor 102 (or 104) may be comparable to a short-range communication device similar to a BLUETOOTH receiving system that allows short-range communication between the input device 100 and a BLUETOOTH type user headset 210. The user headset 210, which is well-known in the art, may transmit audio sounds (i.e., tap, tap-tap, etc.) or verbal expressions (e.g., “click,” “double click,” and “right click”) using the well-known BLUETOOTH communication protocol. In this case, sensor 102 operates as an RF receiver receiving data, decoding the data and then providing a translation of the received data into signals that may be transmitted to the computer system 250, so that the computer system 250 may take the appropriate action.

As would be recognized, the input device 100 may include a table of prefixed audio commands to which the input device 100 may respond. In addition, a user may be able to adapt the table or list of audio commands to provide for further actions (e.g., open, cut, paste, etc.) to cause the input device to generate corresponding commands to a computer system 250.

Similarly, the input device 100 may be in communication with a microphone 215, which provides audio input command signals to device 100. Microphone 215 operates in a manner similar to the operation of the sensor 102 operating as an audio sensor. In this case, the audio inputs from the microphone are provided to the device 100 using, for example, the BLUETOOTH communication protocol. As previously described, the inputted verbal expressions are translated into appropriate signals and provided to a computing system.

In another aspect, the device 100 may be in communication with a foot pedal. 220. The foot pedal 220 may operate to generate an audio sound, similar to a “click” operation when depressed, or a “double click” when two depressions are detected within a prefixed time. That is, a percussion action applied from the foot to the pedal 220 may be interpreted as a tap action. Alternatively, the depression of the foot pedal may trigger wireless signal (Bluetooth) that may be detected by sensor 102.

Thus, in one aspect of the invention, a short-range communication protocols (or wired protocols) may be used to communicate between the foot pedal and the input device 100, while in another aspect of the invention audio sensor 102 may be used to capture an input command signal associated with the depression of the foot pedal.

In other aspect, the device 100 may be in communication with a touch pad 225 (similar to a mouse pad) wherein a tap (percussion or contact) or a double tap on the pad 225 may be interpreted as a click and double click, respectively.

As would be appreciated, the pad 225 may be situated under the mouse and, the moving of the hand off the mouse and tapping pad 225 would be comparable to a button depression of a conventional mouse, and causing the input device 100 to generate signals that would cause the computer system to perform a “click” action. In another aspect, the pad 225 may be positioned on a different side from the input device 100 so that a user must use a second hand to activate the click (double click) operation. That is, the user may move the input device 100 with a right hand, for example, and enter an input command, such as a tap or double tap (corresponding to click and double click, respectively) with the left hand by tapping the pad. Although not shown, it would be recognized that a user may use a touch screen of currently available “smart cellular phone” or tablet computer (for example, Samsung Galaxy TAB) as the pad 225. The smart phones include built in BLUETOOTH communication protocols and, thus, may be adapted to operate as a second input device that operates with a percussion effort or an audio sound or verbal expression. Samsung and Samsung Galaxy TAB are registered trademarks of the Samsung Electronics Co., Ltd. Seoul, Korea.

In still another aspect of the invention, the input device 10 may be in communication with keyboard 230, wherein one of the keys may cause the input device 100 to generate a click or double click response. For example, a “control” key of the keyboard 230, which typically is used in conjunction with a second key, may be used to provide a click, double click operation. In this case, the depression of the control key without a second key would operate as being comparable to a click. In another aspect of the invention, a special key on the key board may be designated as a “click” key. This operation is similar to the operation of a “click” (“double click”) of a conventional mouse, but because a second hand is used to access the designated key, the strain on the user is reduced.

Although the invention of FIG. 2A has been represented as being in communication with input device 100, it would be appreciated that each of the third party devices may be in communication with a corresponding computer system, so that the action occurring on the third party device would be transmitted directly to the computer system.

FIG. 2B illustrates the case where the computer system (Personal Computer) 250 receives information regarding the movement of the input device 100 in accordance with a second embodiment of the invention. In this case, the computer system 250 determines a position of the cursor on the GUI corresponding to the movements provided by the input device 100. In response to an input from one of the third party devices (210, 215, 220, 225, 230), the computer system 250 operates with the input signals as corresponding to one of a click, a double click, a right click, etc. FIG. 2B illustrates an example of this embodiment of the invention wherein computer system 250 is connected to third party devices In this exemplary embodiment, a software program may be loaded into computer system 250 that provides the correlation between the input device 100 and the third party device 210, 215, 220, 225.

As would be recognized, the input device 100 and at least one of the third party devices 210, 215, 220, 225, 230 may be wired to the corresponding computer system 250 or may be a wirelessly connected to the corresponding computer system 250. For example, a conventional wireless keyboard/mouse combination may be adapted to incorporate a software program into the computer system 250 to operate in accordance with the principles of the invention. Similarly, the headset 210 may provide input commands signals to the computer system 250 using an existing short-range communication system. The input commands signals from the headset and the movement of the input device 100, may then be coordinated within computer system 250.

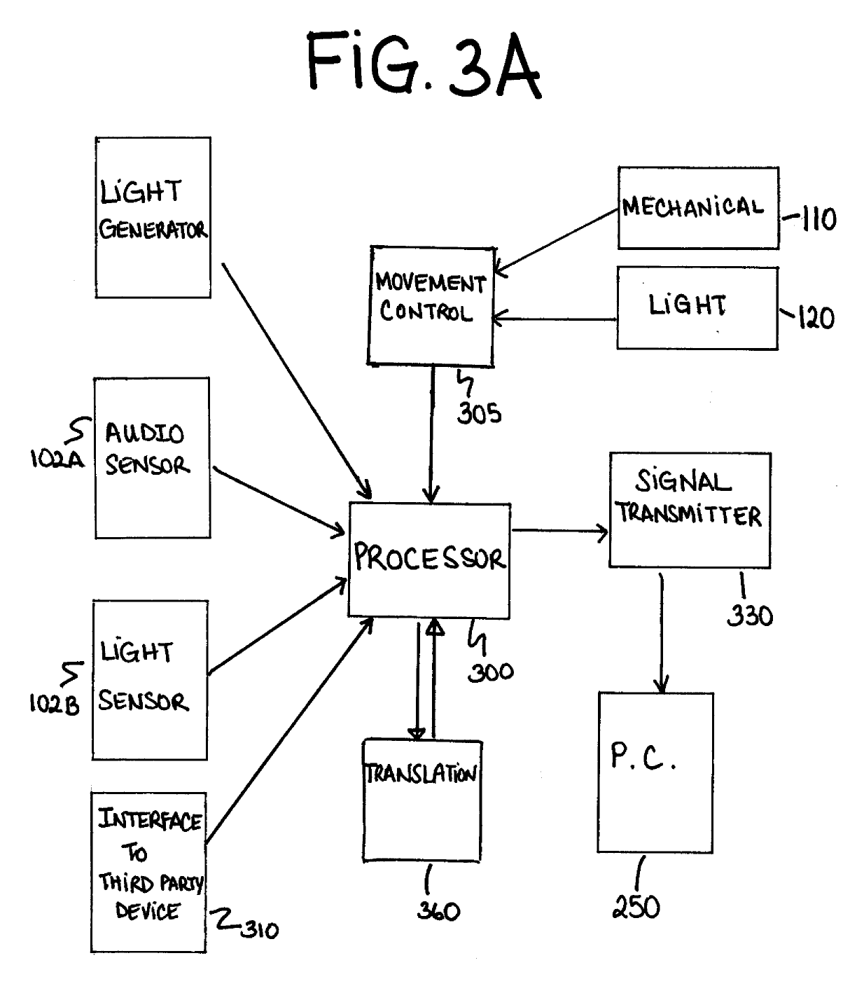

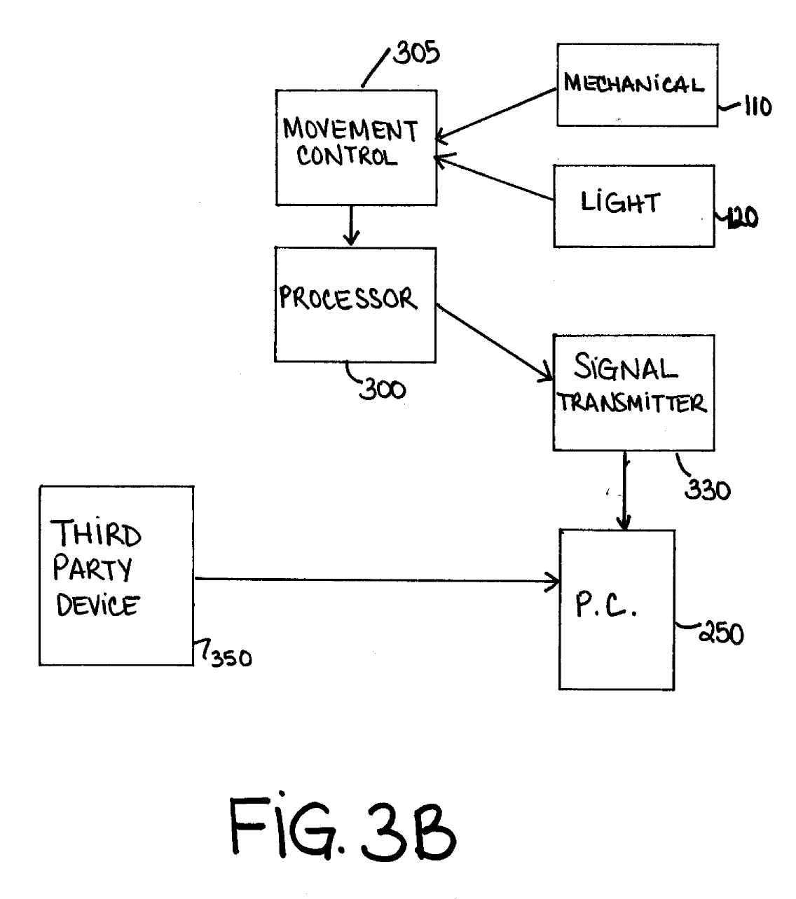

FIG. 3A illustrates a block diagram of an exemplary embodiment of input device 100 in accordance with the first embodiment of the invention. In this exemplary embodiment, the input device 100 includes a processor 300, which is in communication with a movement control mechanism 305. The movement control mechanism may be one of a mechanical one (i.e., ball 110) or light (i.e., laser 1200. In addition, processor is in communication with at least one of an audio sensor 102a and a light sensor 102b. In addition, the input device 100 includes a third party interface 310, which provides communication with at least one of the exemplary third party devices shown in FIG. 2A. As previously discussed, the interface between the input device and the third party device may be one of a short-range wireless communication protocol or a wired communication link. As would be appreciated, the interface 310 may be internal to the input device 100 or external to the input device 100 and be connected to the input device 100 through a commonly available Universal Serial Bus (USB) protocol.

Processor 300 further includes a signal transmitter 330 that provides communication with a computer system 250. The signal transmitter 330 may be connected to the computer system using a wired or a wireless connection. The signal transmitter provides movement indications and “click,” indicates to the computer system 250.

Also shown is a translating function 360 that may be used to translate the received input command signals into signals appropriate for communication with a computing system. For example, a single audio sound (i.e., tap action) that represents an input command signal may be translated into a signal that is electrically and logically compatible with signals that are transmitted to a conventional computing system. Similarly, verbal expressions received as input command signals may be translated into appropriate signals to be transmitted to the computing system. For example, the verbal expression “double click” may be translated into appropriate signals that cause a computing system to sense the existence of two signal clicks within a predetermined time.

FIG. 3B illustrates a block diagram of an exemplary embodiment of input device 100 in accordance with the second embodiment of the invention. In this case, input device 100 includes movement control 305 and signal transmitter 330 as previously described.

Further, the third party devices, represented as block 350, are connected directly to the computer system 250. In this case, computer system correlates the communication between the device 100 and the third party device inputs, as previously discussed.

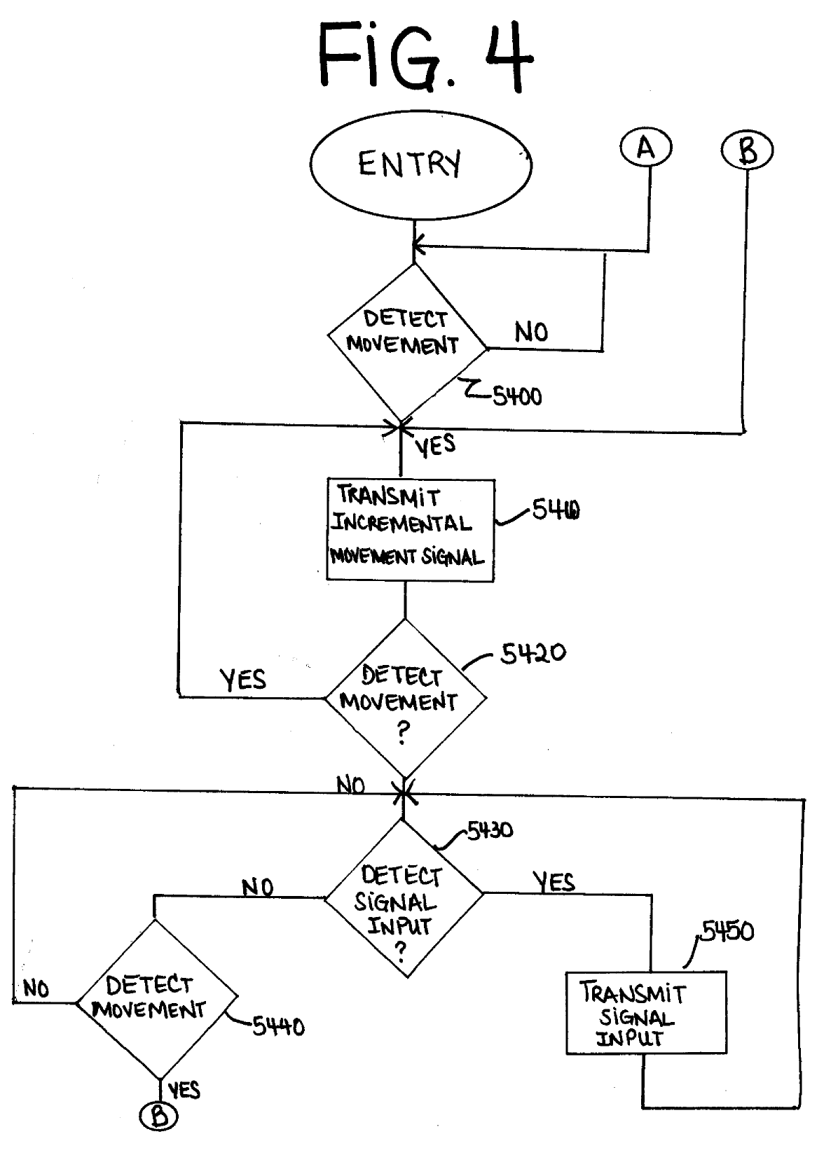

FIG. 4 illustrates a flow chart of an exemplary process in accordance with the first embodiment of the invention. In this case, a determination is made whether movement of input device 100 is detected (S400). If movement is not detected, then processing continues to wait for the detection of movement. When movement is detected, the movement is transmitted to computer system 250 (S410). After the signals are transmitted, a determination is made whether movement is still occurring (S420) and if movement is detected, the indication of movement continues to be transmitted to the computer system 250.

After movement is determined to be halted, a determination is made whether a signal input (i.e., a click) has been detected (S430). If a signal input has not been detected, a check for movement again occurs (S440). If no movement has occurred processing continues at S430 to determine whether a signal input has been received.

However, if movement has been detected at S440, then processing continues to S410 to transmit the detected movement.

However, if an input command signal has been input and detected at S430, then a corresponding signal input is transmitted to the computer system. Processing then continues to monitor whether further signal inputs are received (e.g., double click) at S430.

As would be recognized, if the sensor 102 is an audio sensor 102A, the detection of a first sound (i.e., a tap) is comparable to single button depression on a conventional mouse and a single signal is transmitted to the computer system 250.

In addition, a second sound (i.e., a second tap) is also comparable to a single button depression on a convention mouse and a single signal is transmitted to the computer system 250. The computer system 250 correlates the two transmitted signal (occurring within a predetermined time period) as a “double click.” However, if the two signals are transmitted at a time interval exceeding the predetermined time to be considered a double click, then the two signals are interpreted as two single clicks.

If the sensor 102 is a light sensor 102B, then the detection of a first blockage of light is interpreted as a single button depression on a convention mouse and a single signal is provided to the computer system 250. If the light is further blocked for at least a predetermined period of time, then the light blockage is considered comparable to two depressions and, hence, a second signal is transmitted to computer system 250. The two signals being transmitted after blockage of the light is advantages as it provides the two signals within a period considered to be a double click by the computer system 250, as it does not have the disadvantage of the mechanical motion of the convention mouse button depression.

If the sensor 102 is an RF receiving system, then the input command signals may be interpreted by the input device 100 to provide appropriate signals that are transmitted to the computing system. For example, if the verbal expression “click” is issued, then input device 100 detects the verbal expression and translates the verbal expression to an appropriate signal command. In this example, the appropriate signal command corresponds to a single signal, which corresponds to the single button depression on a conventional mouse. However, if the expression “double click” (or “open, for example) is issued then the input device 100 provides two signals, appropriately spaced in time, to the computer system 250, so that the computer system interprets the two signals as a “double click.” Again, this is advantages as it provides assurance that the double click is performed without having to depress a button twice within a predetermined time as is necessary using a conventional mouse.

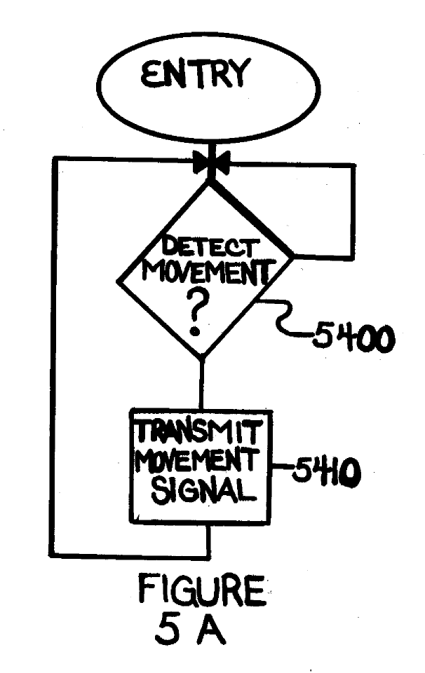

FIGS. 5A and 5B illustrate flow charts of the interaction between input device 100 and computer system 250 in accordance with the second embodiment of the invention.

FIG. 5A illustrates the processing associated with the input device 100. In this illustrative example, input device operates as described with regard to FIG. 4 in detecting motion and providing motion (movement) indications to the computer system 250.

FIG. 5B illustrates the processing associated with computer system 250 in cooperation with the movement indication provided by input device 100. In this case, computer system 250 determines whether movement indications have been received from device 100 (S510). If not then, a movement-in-progress indication is cleared (S520) and processing continues to S540 to determine whether a signal input has been received. If a signal has not been received, then processing continues to monitor whether a movement has been detected (S510).

However if movement has been detected, then a movement-in-progress indication has set (S530) and processing continues to S540 to determine whether a signal input has been received. If a signal has been received, then a determination is made whether the movement-in-progress indication is set (S550). If set then, the signal is discarded and processing continues to monitor receipt of movement indications at S510.

However, if a S550, the movement-in-progress indication is not set, the computer system 250 operates on the signal received (S560).

As previously discussed, when the signal is provided by a microphone or a headset, the verbal command (e.g., click, double click, etc.) may be appropriately translated to provide the proper signal(s) so that the appropriate action may be completed.

In another aspect of the invention, one common operation of the conventional mouse is what is referred to as “click and drag,” wherein depressing a button and moving the mouse causes the computer system 250 to capture (select) an element (e.g., an icon) on the GUI associated with a current position of a cursor (which is associated with a current position of the mouse) and move the captured icon in response to the movement of the mouse. The drag operation continues as long as the button remains depressed.

In accordance with the principles of the invention, a “click and drag” operation may be similarly performed. For example with reference to the first embodiment of the invention, wherein sensor 102 is an audio sensor, a first sound may be associated with a click, as previously described, and a second sound (e.g., a whistle) that extends for a predetermined period may be considered a “drag.” Thus, elements that are selected by the “click” (i.e., first sound) may then be dragged for the duration of the second sound.

Similarly, when sensor 102 is a light sensor, a first light blockage may be associated with a click, as previously described, and a second light blockage that exceeds for a predetermined period may be considered a “drag.” Thus, elements that are selected by the “click” (i.e., first sound) may then be dragged for the duration of the light blockage. For example, the sensor 102 may be positioned to detect the presence of ambient light in the local environment. When the ambient light is blocked, then an input command signal is generated. In another aspect, the sensor 102, may generate a low-level light which when blocked is deemed to generate a corresponding input command signal.

When the sensor 102 is replaced by an interface to a third party device (310), operation of device 100 may interpret verbal commands, such as “click and drag” into appropriate signals so that computer system 250 responds accordingly. A second command, for example, “release” may be interpreted as releasing the selected element (icon) and ending the dragging operation.

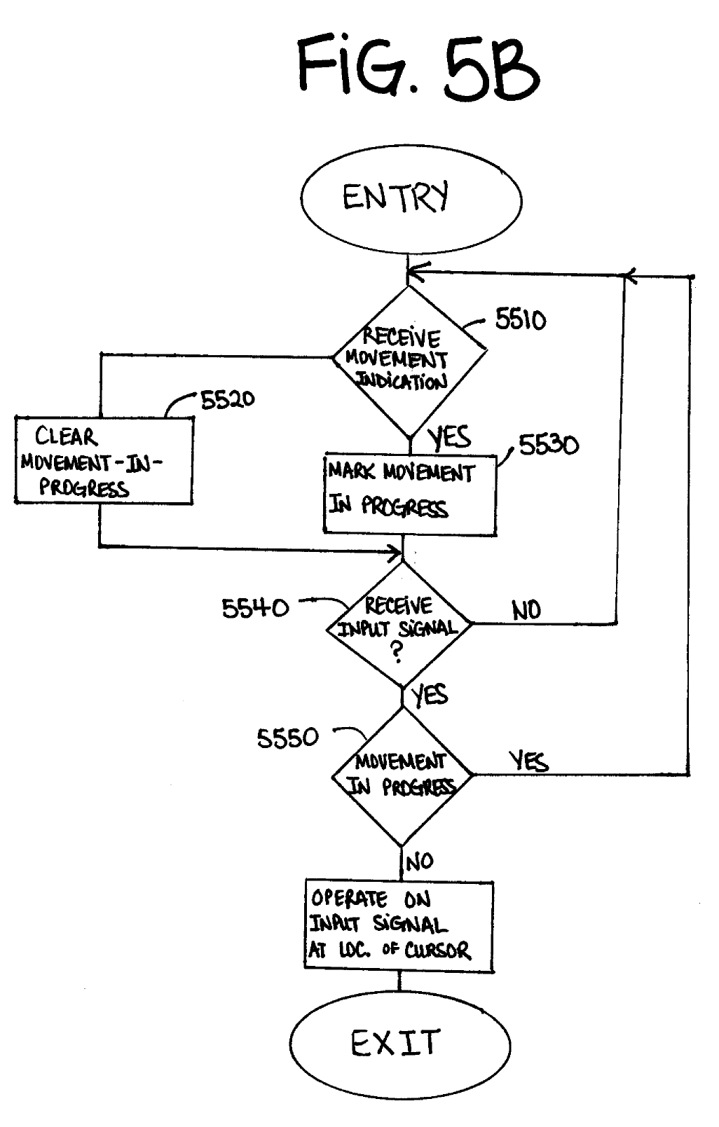

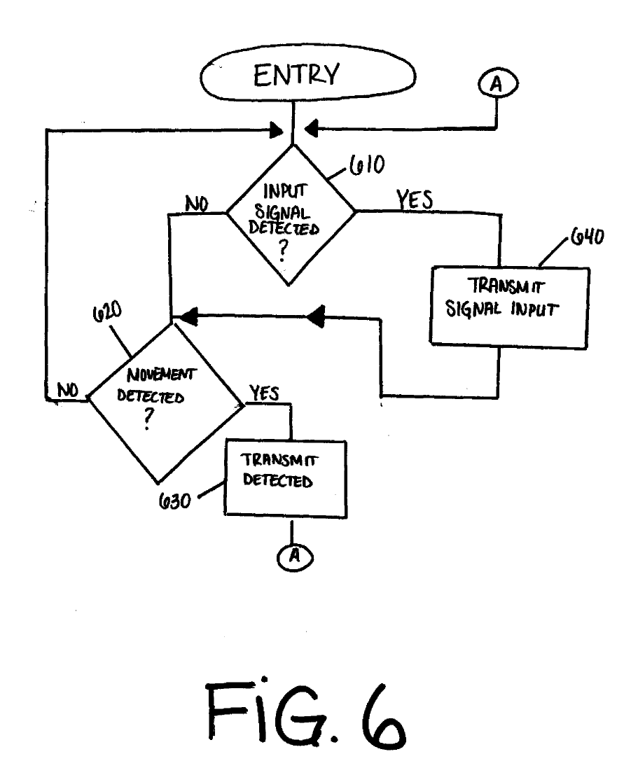

FIG. 6 illustrates an exemplary process for performing a “click and drag” operation in accordance with the first embodiment of the invention. In this illustrative example, a determination is made whether an input command signal has been detected (S610). If an input command signal has been detected, the input command signal is translated into a corresponding appropriate signal that is transmitted to the computer system 250 (S640). Processing then determines whether movement has been detected at S620. If movement has been detected, then the movement is transmitted to the computer system 250 and processing continues at S610 to determine whether the input command signal is still present. If the signal is still present, then the signal is transmitted to the computer system 250 and processing again determines whether movement has occurred (S 620). If movement is not detected, the processing continues to S610 to determine whether the input signal is still present. If the input command signal is no longer present, then processing continues to determine whether movement has been detected (S620).

The drag operation continues until the computer system 250 fails to receive further input signal transmissions or an input command signal causes the release of the captured icon.

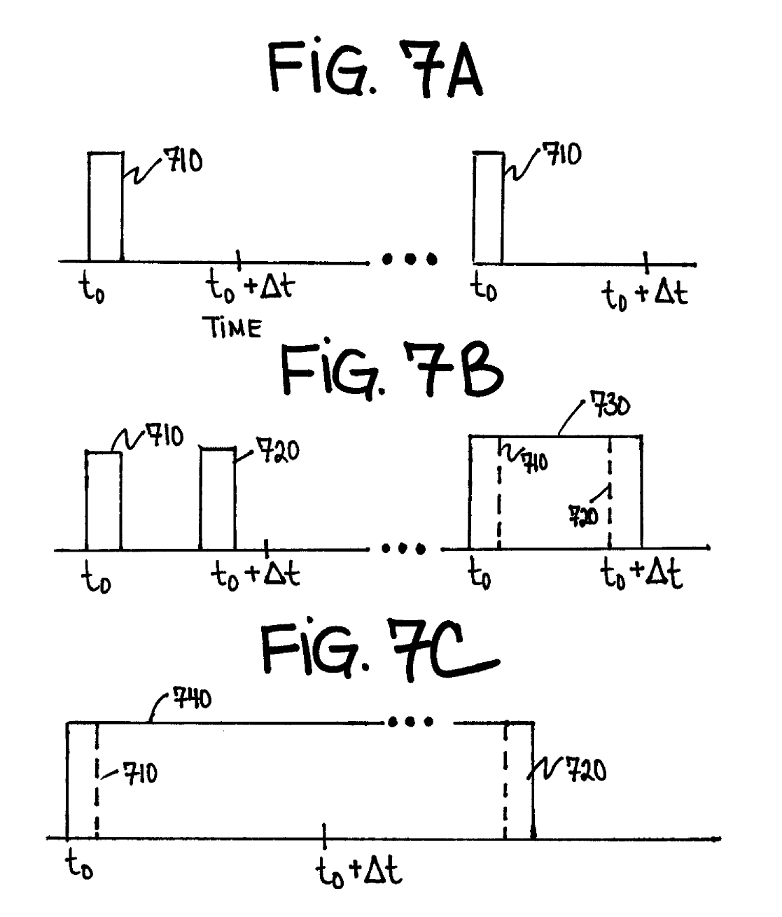

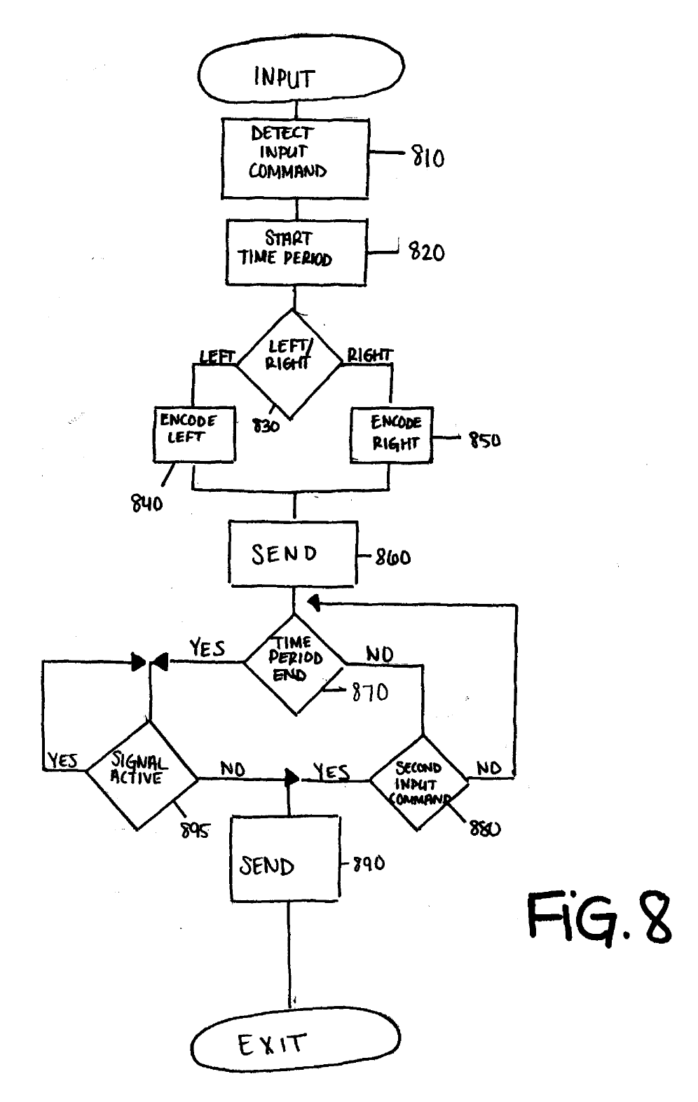

FIG. 7A illustrates an exemplary signal timing diagram associated with a single input command signal. In this exemplary case, generation or detection of single input command signal at time t₀ (i.e., a first time), creates a time period of a first predetermined time. The first predetermined time extending from time t₀ to time t₀+Δt. If only one input command signal is generated or detected in this first predetermined time period, then a corresponding signal 710 is provided to the computing system. The computer system then operates on the provided signal. As would be appreciated, the signal 710 provided to the computer system may be a single pulse of a known duration, which is interpreted by the computer system to perform an associated (first) function (e.g., a click). In another aspect, the signal 710 provided to the computer system may be an encoded signal (for example, Manchester encoded, wherein a single pulse is transmitted as two pulses to remove a direct current component from the signal transmission). In addition, the signal 710 associated with the single input command signal may be encoded to provide information regarding whether the input command signal is associated with a “left” button or a “right” button.

This process is repeated for each detection of an input command signal or that is not detected within the first predetermined time period.

FIG. 7B illustrates an exemplary signal timing diagram associated with two input command signals detected within the first predetermined time period. In this case, a first input command signal initiates the first predetermined time period as previously described. A second input command signal is then detected within the first predetermine time period. In this case, the input devices provides two signals 710, 720 corresponding to the two detected input command signals to the computing system. The computer system interprets the two signals received within the predetermined time period as a double click and performs a second operation associated with a double click. As would be appreciated, the signal 710 may initiate a timer in the computer system and the second signal 710 may be measured by the computing system to be within the predetermined time period. Hence, the decision regarding single or double click is made in the computing system.

FIG. 7B also illustrates a second aspect of the invention wherein a signal 730 beginning at time t₀ is continuously active for the first predetermined time period. In this case, two signals may be provided to the computing system in a manner similar to when two input command signals are detected within the first predetermined time period. That is, a first signal, 710, represented by a dashed line may be sent to the computing system at time t₀ and a second signal 720 may be transmitted at the end of the first predetermined time period. Thus, a single input command signal is represented as two signals to the computer system.

FIG. 7C illustrates another exemplary timing diagram in accordance with the principles of the invention. In this case, detection of a first input command signal at t₀ causes a first signal 710 to be generated and provided to the computer system. As the signal remains continuously active during the first predetermined time period, the input command signal is continuously monitored and if the signal remains active for the entire first predetermined time period, then a determination is made when the input command signal ends. When an end of the input command signal 740 is detected, a second signal 720 is provided to the computer system to execute a third function (a drag and click).

FIG. 8 illustrates an exemplary process for managing input command signals In this illustrative example, an input command signal is detected at step 810. A time period is initiated at the step 820. At step 830, a determination is made whether the input command signal is associated with a left or a right click action and an appropriate signal is generated in steps 840 and 850 to distinguish between the left and right clicks. The encoded signal is then transmitted to the computing system at step 860. At step 870, a determination is made whether the time period has expired. If the answer is no, then a determination is made whether a second input command has been detected. If not, then the processing returns to step 870 to await the end of the time period. However, if a second input command signal has been detected and the input command signal is still active, then a signal is sent to the computing system.

Returning to step 870, if the time period has expired, then a determination is made on whether the signal is still active. If the answer is no, then a second signal is provided to the computing system, in a manner similar to that of two input command signals being received within the predetermined time.

However, if the signal is still active after the first predetermined time period, then the signal is monitored until the signal is no longer active. In this case, a second signal is provided to the computing system.

The computing system in response to the received signal(s) may perform a first function if a single signal is received within the predetermined period, a second function if two signals are received within the predetermined period and a third function if the second signal is not received within the predetermined period. Although, not shown it would be appreciated, that the computing system is able to distinguish the case between that illustrated in FIG. 7A and FIG. 7C, wherein only one signal is received within the predetermined period. How this distinguishing is performed is beyond the scope of the present invention and need not be described in detail herein.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While there has been shown, described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An input device for providing at least one type of input signal to a computing system, comprising:
means for determining a movement of said input device,
means for receiving at least one input command signal, said means for receiving comprising at least one of: an audio sensor, a light sensor, and a receiver, and
means for providing said determined movement and signals associated with said received at least one input command signal to the computer system, wherein the provided signals cause the computer system to execute a function associated with an element at a location associated with said determined movement.

2. The input device of claim 1, wherein the receiver represents a short-range communication system.

3. The input device of claim 2, wherein the receiver is capable of detecting at least one of: an audio signal, a light signal, and a contact signal.

4. The input device of claim 1, wherein said audio sensor receives said at least one command input signal generated by at least one of: a verbal expression and a percussion event.

5. The input device of claim 5, wherein the percussion event is associated with a tapping action causing generation of an audio sound.

6. The input device of claim 1, wherein the means of providing the determined movement and the at least one command signal is one of: a wireless connection and a wired connection.

7. The input device of claim 1, wherein detection of a single one of the at least one command input signals within a first predetermined time period causes the computer system to execute a first function at a position associated with the provided determined movement.

8. The input device of claim 1, wherein detection of two of the at least one input command signals within a first predetermined time period causes the computer system to execute a second function at a position associated with the provided determined movement.

9. The input device of claim 1, wherein detection of a single one of the at least one input command signals is continuously active for a first predetermined time period causes the computer system to execute a second function at a position associated with the provided determined movement.

10. The input device of claim 7, wherein detection of a single one of the at least one input command signals is continuously active for a period greater than the first predetermined time period causes the computer system to execute a third function at a position associated with the provided movement.

11. The input device of claim 1, further comprising:
means for translating an input command signal received into corresponding signal provided to the computer system, wherein the input command signal is one of: an audio sound, a verbal expression and a lack of an optical signal.

12. A system comprising:
a first input device and a second input device, the first device providing input command signals to the second input device, which provides communication with a computing system;
the first input device comprising:
means for receiving at least one input command signal; and
means for transmitting the received at least one input command signal to the second input device; and
the second input device comprising:
means for receiving the at least one input command signal comprises one of: an audio sensor, an optical sensor and a short-range communication system;
means for determining a movement of the second input device, and
means for transmitting the determined movement and signals associated with the received at least one input command signals to the computer system; wherein the computer system executes a function associated with a position determined by the determined movement based on the signals associated with the received at least one input command signal.

13. The system of claim 12, wherein the first input device is one of: an audio device, a contact device and an optical device.

14. The system of claim 12, wherein the second device further comprises;
means for translating the received input command signal into corresponding signals for transmission to the computer system.

15. The input device of claim 11, wherein the short-range communication system is capable of detecting at least one of: an audio signal and an optical signal.

16. A method for providing communication between a computing system and an input device, the method comprising the steps of:
determining a movement of the input device;
receiving at least one input command signal, wherein the at least one input command signal is one of; an audio input, an optical input and an radio frequency input;
translating the received at least one input command signal into signals appropriate for communication with the computing system, and
transmitting the signals appropriate for communication with the computing system, wherein the computer system executes at least one function associated with the determined movement and the transmitted signals.

17. The method of claim 16, wherein the audio input is one of: an audio sound and a verbal expression.

18. The method of claim 16, wherein the input command signals are associated with at least one of: an audio signal, and a light signal.
